(19) United States
(12) Patent Application Publication
(10) Pub. No.: US 2020/0363026 A1
(43) Pub. Date: Nov. 19, 2020

(54) WALL-MOUNTED SOLAR LAMP

(71) Applicant: Joseph Y. Ko, Laguna Niguel, CA (US)

(72) Inventor: Joseph Y. Ko, Laguna Niguel, CA (US)

(21) Appl. No.: 16/412,865

(22) Filed: May 15, 2019

(51) Int. Cl. F21S 8/00; F21S 9/03; F21V 23/04; F21V 23/00

(52) U.S. Cl. CPC F21S 8/033; F21S 9/037; F21Y 2115/10; F21V 23/005; F21V 23/04

(57) ABSTRACT

A wall-mounted solar lamp disposed on a building wall surface by connectors, comprising a casing, a solar panel disposed on the casing, a battery disposed in the casing and connected to the solar panel, and a first light projecting unit disposed at a side of the casing. The casing defines a first surface contacting the building wall surface when assembled, and a second surface parallel to the first surface and mounted with the solar panel. The first surface is formed with lateral mounting holes and longitudinal mounting holes. The casing comprises a first installation state in which the lateral mounting holes are assembled with the connectors to enable the solar lamp to project light in parallel with a ground, and a second installation state in which the longitudinal mounting holes are assembled with the connectors to enable the solar lamp to project light perpendicular to the ground.

### FIELD OF THE INVENTION

The present invention relates to a solar wall lamp, and more particularly to a wall-mounted solar lamp which is capable of changing the installation state without being limited by a solar panel.

### BACKGROUND OF THE INVENTION

In order to provide light source for the home courtyard in the evening, most people choose to install a wall lamp in the courtyard to provide lighting. However, most of the conventional wall lamps are provided with a solar panel at the top of the wall lamp to receive irradiation from the sun, and thus the solar panel will limit the assembly state of the wall lamp, making it impossible for the user to change the assembly state of the wall lamp according to the implementation requirements.

### SUMMARY OF THE INVENTION

A main object of the present invention is to solve the problem that the installation state of the conventional solar wall lamps cannot be changed due to structural limitations.

In order to achieve the above object, the present invention provides a wall-mounted solar lamp, the wall-mounted solar lamp can be disposed on a building wall surface by a plurality of connectors. The wall-mounted solar lamp comprises a casing, a solar panel, a battery, and a first light projecting unit. The casing defines a first surface contacting the building wall surface when assembled, a second surface parallel to the first surface, and at least one light-transmissive end located at a side of the casing. On the first surface of the casing is formed with a plurality of lateral mounting holes, and a plurality of longitudinal mounting holes perpendicular to the plurality of lateral mounting holes. The casing has a first installation state in which the plurality of lateral mounting holes are assembled with the plurality of connectors to enable the wall-mounted solar lamp to project light in parallel with a ground, and a second installation state in which the plurality of longitudinal mounting holes are assembled with the plurality of connectors to enable the wall-mounted solar lamp to project light perpendicular to the ground. The solar panel is flatly disposed on the second surface. The battery is disposed in the casing and connected to the solar panel. The first light projecting unit is disposed at the at least one light-transmissive end, and comprises a first circuit board installed in the casing and located at the at least one light-transmissive end, a light-emitting control circuit disposed on the first circuit board and obtained electric power from the solar panel or the battery, and a plurality of first light-emitting diodes disposed on the first circuit board and connected to the light-emitting control circuit.

In one embodiment, the wall-mounted solar lamp defines the two light-transmissive ends at two sides, one of the light-transmissive ends is provided with the first light projecting unit, and the other one of the light-transmissive ends is provided with a second light projecting unit electrically connected to the first light projecting unit. The second light projecting unit comprises a second circuit board, a power transmission circuit disposed on the second circuit board and connected to the light-emitting control circuit to obtain electric power, and a plurality of second light-emitting diodes disposed on the second circuit board and connected to the power transmission circuit. Further, the casing is composed of a U-shaped shell and a cover plate, the U-shaped shell comprises two side walls disposed in parallel with each other, a panel disposed between the two side walls and provided with the second surface, and an installation space defined and formed by the two side walls and the panel. The two side walls are formed with a plurality of mounting rails respectively provided for disposal of the first circuit board and the second circuit board. The cover plate is connected to the two side walls of the U-shaped shell, and the cover plate is provided with the plurality of longitudinal mounting holes and the plurality of lateral mounting holes.

In one embodiment, the casing comprises a mounting seat located in the installation space and mounted on the panel for disposal of the battery.

In one embodiment, the wall-mounted solar lamp comprises a hood disposed in the casing and corresponding to the plurality of longitudinal mounting holes and the plurality of lateral mounting holes.

In one embodiment, the two side walls are respectively formed with a mounting rail for disposal of the first circuit board.

In one embodiment, each of the plurality of lateral mounting holes defines a first inlet section and at least one first limit section connecting the first inlet section to limit one of the plurality of connectors being detached from the plurality of lateral mounting hole. Each of the plurality of longitudinal mounting holes defines a second inlet section and at least one second limit section connecting the second inlet section to limit one of the plurality of connectors being detached from the plurality of longitudinal mounting hole.

In one embodiment, the wall-mounted solar lamp comprises a switch disposed on the casing and connected to the light-emitting control circuit.

According to the foregoing disclosed content of the present invention, the present invention comprises the following features as compared with the conventional techniques:

The solar panel of the present invention is disposed on the second surface, so that a user can change the direction of the wall-mounted solar lamp freely, and is no longer limited by the solar panel. On the other hand, the casing is formed with the plurality of lateral mounting holes and the plurality of longitudinal mounting holes perpendicular to the plurality of lateral mounting holes on the first surface, so that the user can select the wall-mounted solar lamp to enter the first installation state or the second installation state according to requirements, and thus greatly enhances the convenience of the wall-mounted solar lamp.

### BRIEF DESCRIPTION OF THE DRAWINGS

FIG. 1 is a perspective view of the structure of one embodiment of the present invention;

FIG. 2 is an exploded perspective view of one embodiment of the present invention;

FIG. 3 is a cross-sectional view of one embodiment of the present invention;

FIG. 4 is a schematic view of units of one embodiment of the present invention;

FIG. 5 is a structural schematic view of the present invention in a first installation state;

FIG. 6 is a structural schematic view of the present invention in a second installation state;

FIG. 7 is a cross-sectional view of another embodiment of the present invention; and

FIG. 8 is a schematic view of units of another embodiment of the present invention.

### DETAILED DESCRIPTION OF THE PREFERRED EMBODIMENTS

The detailed description and technical content of the present invention will now be described with reference to the accompanying drawings as follows.

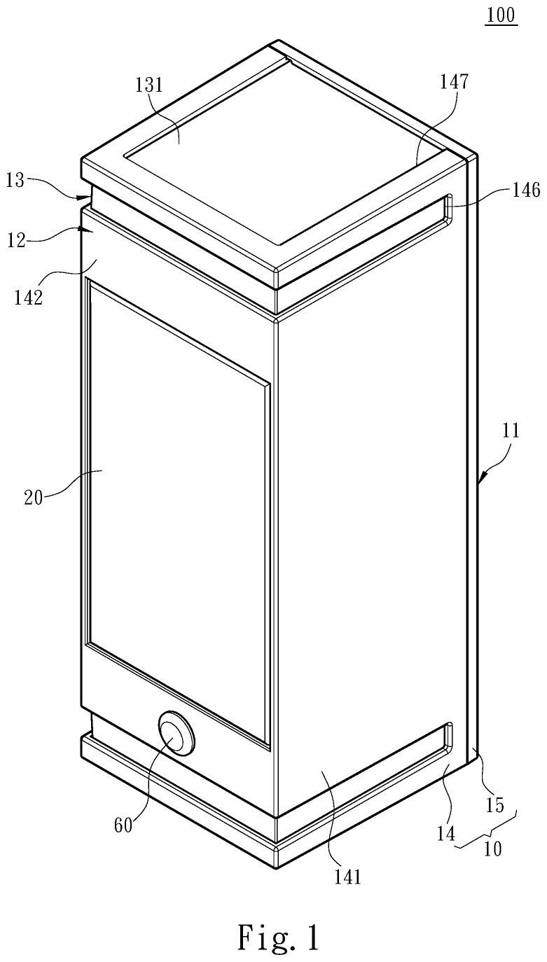

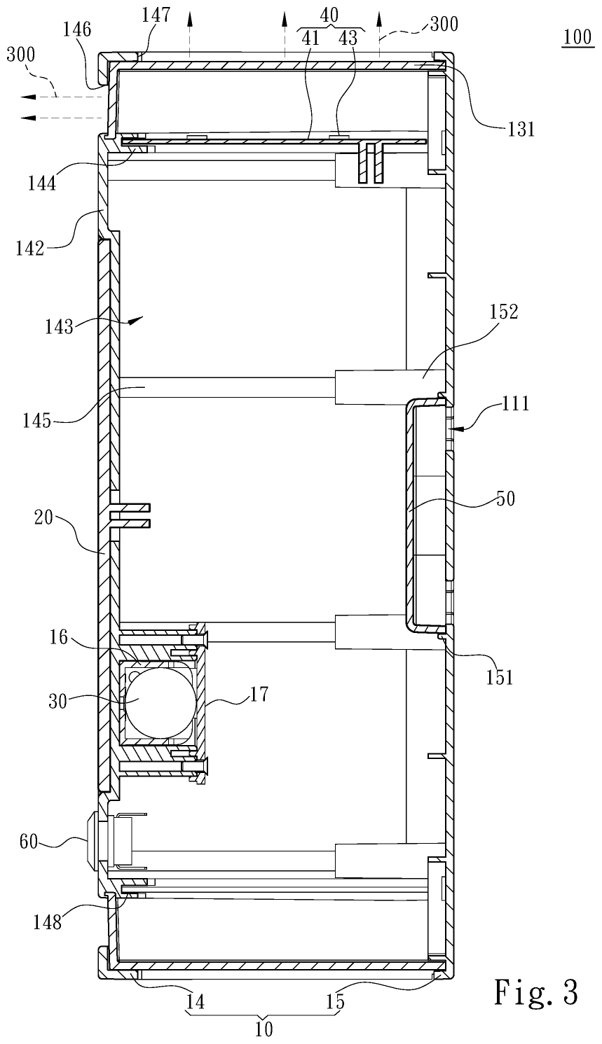

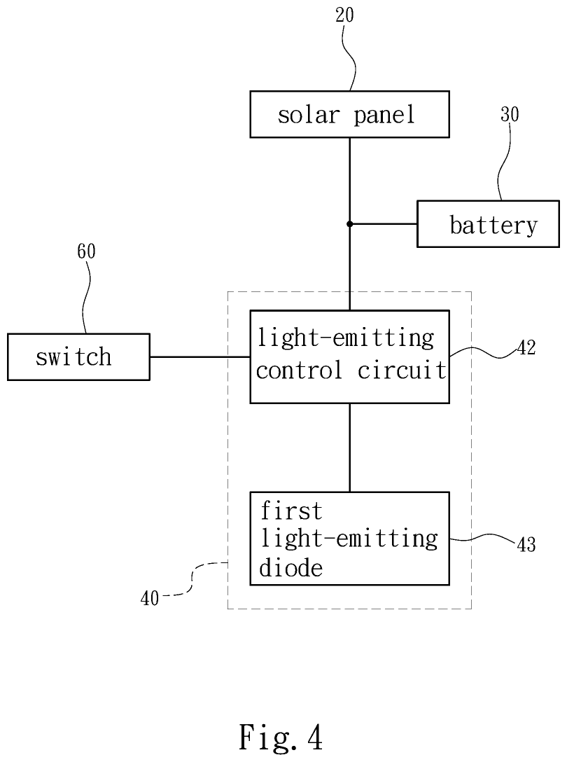

Referring to FIGS. 1, 2, 3, 4, 5 and 6, the present invention provides a wall-mounted solar lamp 100. The wall-mounted solar lamp 100 can be disposed on a building wall surface (not shown in the figures) by a plurality of connectors 200, wherein the wall-mounted solar lamp 100 comprises a casing 10, a solar panel 20 disposed on the casing 10, a battery 30 disposed in the casing 10 and connected to the solar panel 20, and a first light projecting unit 40. Specifically, the casing 10 is a columnar body, and the casing 10 defines a first surface 11 that contacts the building wall surface when assembled, a second surface 12 paralleled the first surface 11 and provided with the solar panel 20, and at least one light-transmissive end 13 located at a side of the casing 10. Further, the first surface 11 of the casing 10 is formed with a plurality of lateral mounting holes 111 and a plurality of longitudinal mounting holes 112 perpendicular to the plurality of lateral mounting holes 111. Each of the plurality of lateral mounting holes 111 is disposed in parallel with one another, and each of the longitudinal mounting holes 112 is also disposed in parallel with one another. On the other hand, the first light projecting unit 40 is disposed at the at least one light-transmissive end 13, and the first light projecting unit 40 comprises a first circuit board 41 installed in the casing 10 and located at the at least one light-transmissive end 13, a light-emitting control circuit 42 disposed on the first circuit board 41, and a plurality of first light-emitting diodes 43 disposed on the first circuit board 41 and connected to the light-emitting control circuit 42. The light-emitting control circuit 42 receives electric power provided by the solar panel 20 or the battery 30, and the plurality of first light-emitting diodes 43 receive electric power from the light-emitting control circuit 42 to emit a light 300 respectively.

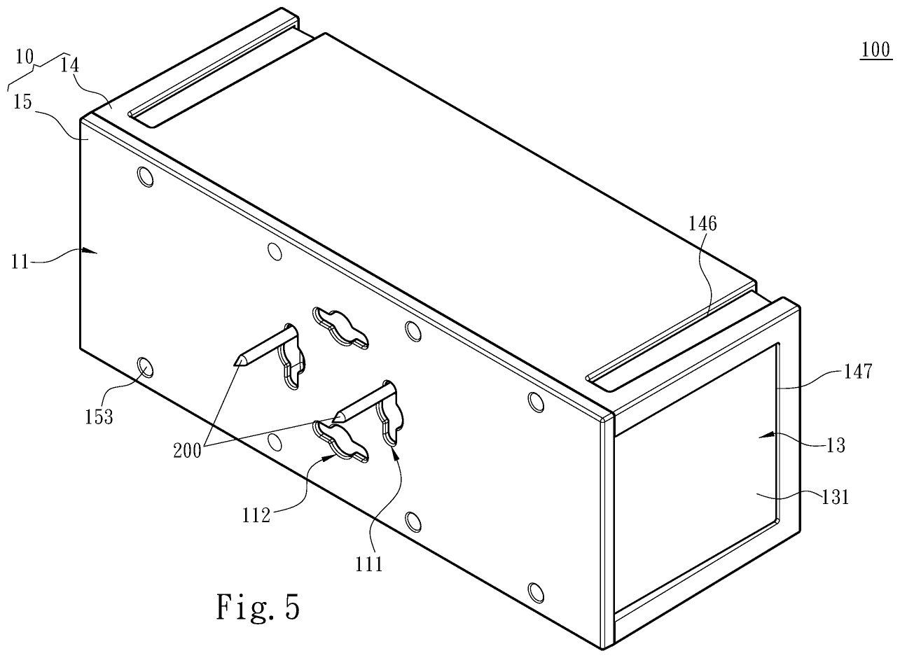

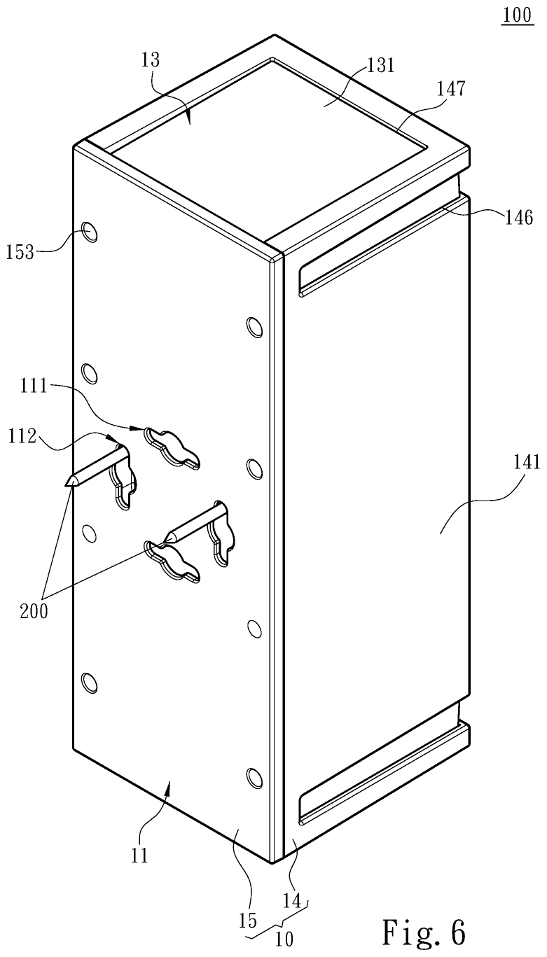

The casing 10 comprises a first installation state in which the plurality of lateral mounting holes 111 are assembled with the plurality of connectors 200, and a second installation state in which the plurality of longitudinal mounting holes 112 are assembled with the plurality of connectors 200. In detail, when the casing 10 enters the first installation state, the wall-mounted solar lamp 100 projects light parallel to a ground (as shown in FIG. 5), and when the casing 10 enters the second installation state, the wall-mounted solar lamp 100 projects light perpendicular to the ground (as shown in FIG. 6). Thereby, the wall-mounted solar lamp 100 comprises different light-projecting directions by selecting the plurality of lateral mounting holes 111 or the plurality of longitudinal mounting holes 112 to be assembled with the plurality of connectors 200. Further, the solar panel 20 of the wall-mounted solar lamp 100 of the present invention is disposed on the second surface 12 instead of the at least one light-transmissive end 13 of the wall-mounted solar lamp 100, that is, when a user wants to change the assembled state of the wall-mounted solar lamp 100, the wall-mounted solar lamp 100 is not limited by the solar panel 20 when switching between the first installation state and the second installation state.

Referring to FIGS. 1, 2 and 3, in one embodiment, each of the plurality of lateral mounting holes 111 respectively defines a first inlet section 113 and at least one first limit section 114 connecting the first inlet section 113, and the first inlet section 113 of each of the plurality of lateral mounting holes 111 is respectively provided for one of the plurality of connectors 200 to insert into. Further, each of the plurality of connectors 200 comprises a limiting portion 201 and a connecting portion 202 connecting the limiting portion 201. A size of the limiting portion 201 of each of the plurality of connectors 200 is larger than a diameter of the first limit section 114 of each of the plurality of lateral mounting holes 111, and smaller than a diameter of the first inlet section 113 of each of the plurality of lateral mounting holes 111; that is, the limiting portion 201 of one of the connectors 200 enters the first inlet section 113 of one of the plurality of lateral mounting holes 111, and the connecting portion 202 of the connectors 200 slides to the first limit section 114 of the plurality of lateral mounting holes 111. At the same time, because a size of the limiting portion 201 of one of the plurality of connectors 200 is larger than a diameter of the first limit section 114 of one of the plurality of lateral mounting holes 111, one of the plurality of connectors 200 is in a fasten relationship with the casing 10 to mount the wall-mounted solar lamp 100 on the building wall surface. On the other hand, the plurality of longitudinal mounting holes 112 also respectively define a second inlet section 115 and at least one second limit section 116 connecting the second inlet section 115. The efficacies of the second inlet section 115 and the second limit sections 116 are the same as foregoing mentioned the first inlet section 113 and the first limit section 114, and thus are not described herein again. In addition, in one embodiment, each of the plurality of lateral mounting holes 111 respectively communicates with one of the plurality of longitudinal mounting holes 112, so that each of the plurality of lateral mounting holes 111 is formed in an L shape with ssone of the plurality of longitudinal mounting holes 112.

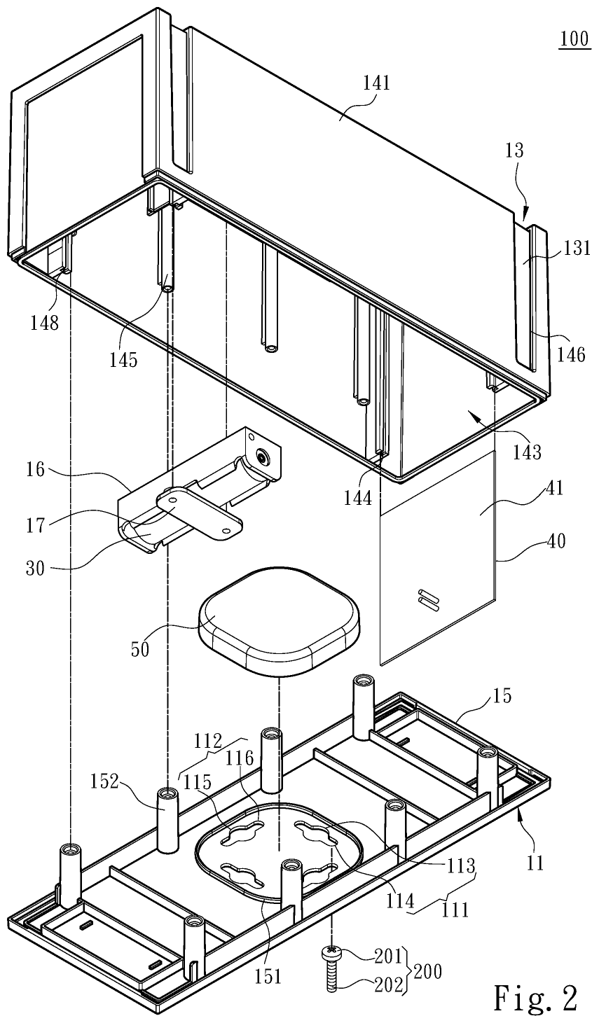

Referring to FIGS. 1 and 2, in one embodiment, the casing 10 is composed of a U-shaped shell 14 and a cover plate 15, wherein the U-shaped shell 14 comprises two side walls 141 disposed in parallel with each other, a panel 142 disposed between the two side walls 141 and provided with the second surface 12, and an installation space 143 defined by the two side walls 141 and the panel 142. Further, the panel 142 is mounted with a mounting seat 16 for disposal of the battery 30, and a blocking plate 17 mounted on the mounting seat 16 to limit the battery 30 being detached from the mounting seat 16. The two side walls 141 are respectively formed with a plurality of mounting rails 144 for disposal of the first circuit board 41, the plurality of mounting rails 144 enable the first circuit board 41 to be quickly pulled out or inserted into, and enable the first circuit board 41 to be obtained a limited position. In addition, the first circuit board 41 of the present invention does not have to be fixed on the U-shaped shell 14 through the limited position of the plurality of mounting rails 144. On the other hand, the cover plate 15 is the first surface 11 formed by the casing 10. The cover plate 15 is formed with the plurality of lateral mounting holes 111 and the plurality of longitudinal mounting holes 112. In one embodiment, in order to prevent external foreign matters from entering the installation space 143, the wall-mounted solar lamp 100 is provided with a hood 50 located in the installation space 143 and assembled with the cover plate 15. The cover plate 15 is formed with a positioning ring 151, and the plurality of lateral mounting holes 111 and the longitudinal mounting holes 112 are disposed in a region surrounded by the positioning ring 151. The hood 50 is disposed corresponding to the positioning ring 151 and shields the plurality of lateral mounting holes 111 and the plurality of longitudinal mounting holes 112, thereby external foreign matters cannot enter the installation space 143 from the plurality of lateral mounting holes 111 or the plurality of longitudinal mounting holes 112.

Referring to FIGS. 1, 2, 3, 4, 5 and 6, in one embodiment, the U-shaped shell 14 is formed with a plurality of first assemble tubes 145 extending in a direction toward the cover plate 15, and the cover plate 15 is formed with a plurality of second assemble tubes 152 extending in a direction toward the U-shaped shell 14 and corresponding to one of the plurality of first assemble tubes 145, respectively. The U-shaped shell 14 and the cover plate 15 are assembled with each other through the plurality of first assemble tubes 145 and the plurality of second assemble tubes 152 to form a connection relationship. Further, the cover plate 15 is formed with a plurality of assemble holes 153 thereon to respectively communicate with one of the plurality of second assemble tubes 152, and each of the plurality of assemble holes 153 is respectively provided for an assemble element (not shown in the figures) to insert, so that one of the plurality of second assemble tubes 152 is connected to one of the plurality of first assemble tubes 145. Referring to FIGS. 1, 2, 3 and 4, in one embodiment, the solar panel 20 will output a photovoltaic power when the solar panel 20 receives light, and the solar panel 20 depends on whether the wall-mounted solar lamp 100 is activated or not, so as to determine to input the photovoltaic power to the light-emitting control circuit 42 for projecting light, or input the photovoltaic power to the battery 30 for standby charging to store electric power required for projecting light when the environment is without light source. In other words, the wall-mounted solar lamp 100 of the present invention does not have to be connected to an external power source, but only provides electric power required for projecting light through the solar panel 20 or the battery 30. Further, the wall-mounted solar lamp 100 of the present invention comprises a switch 60 disposed on the casing 10 and connected to the light-emitting control circuit 42. When the switch 60 is operated, a control signal is sent to enable the wall-mounted solar lamp 100 to be turned on or turned off. In addition, besides the wall-mounted solar lamp 100 determines whether to activate or not by operating the switch 60, in one embodiment, the light-emitting control circuit 42 determines whether the wall-mounted solar lamp 100 projecting light or to be charged according to a size of the photovoltaic power that is received. Specifically, the size of the photovoltaic power is determined by an intensity of light received by the solar panel 20, and the light-emitting control circuit 42 can be configured with a starting power reference, and the determining element of the starting power reference is the size of the photovoltaic power. When the photovoltaic power generated by the solar panel 20 is greater than the starting power reference, the light-emitting control circuit 42 determines that the current environment is in a high light source state, so as to enable the wall-mounted solar lamp 100 to be charged, and when the photovoltaic power generated by the solar panel 20 is smaller than the starting power reference, the light-emitting control circuit 42 determines that the current environment is in a low light source state and drives the plurality of first light-emitting diodes 43 to project light.

In one embodiment, in addition to comprising a constant light mode after startup and an inactivated standby mode, the wall-mounted solar lamp 100 further comprises a blinking projection mode in which the plurality of first light-emitting diodes 43 are caused to project light intermittently. The switch 60 transmits the control signal according to the operation, so as to enable the wall-mounted solar lamp 100 to enter one of the above-mentioned light projection modes. In addition, in one embodiment, the switch 60 can be a push switch or a toggle switch, wherein the push switch sends the different control signals according to the number of presses, and the toggle switch sends the different control signals according to different switch positions.

Referring to FIGS. 1, 2 and 3, in order to enhance the lighting effect of the wall-mounted solar lamp 100, in one embodiment, the at least one light-transmissive end 13 of the U-shaped shell 14 is formed with a first opening 146 located on the two side walls 141 and the panel 142, and a second opening 147 located between the two side walls 141 and the panel 142. The first opening 146 and the second opening 147 allow the light 300 to be projected out there so that the wall-mounted solar lamp 100 projects light more directional. Further, the wall-mounted solar lamp 100 is provided with a light guiding member 131 at the at least one light-transmissive end 13, and the first opening 146 and the second opening 147 are unable to communicate with the installation space 143 after the light guiding member 131 is disposed.

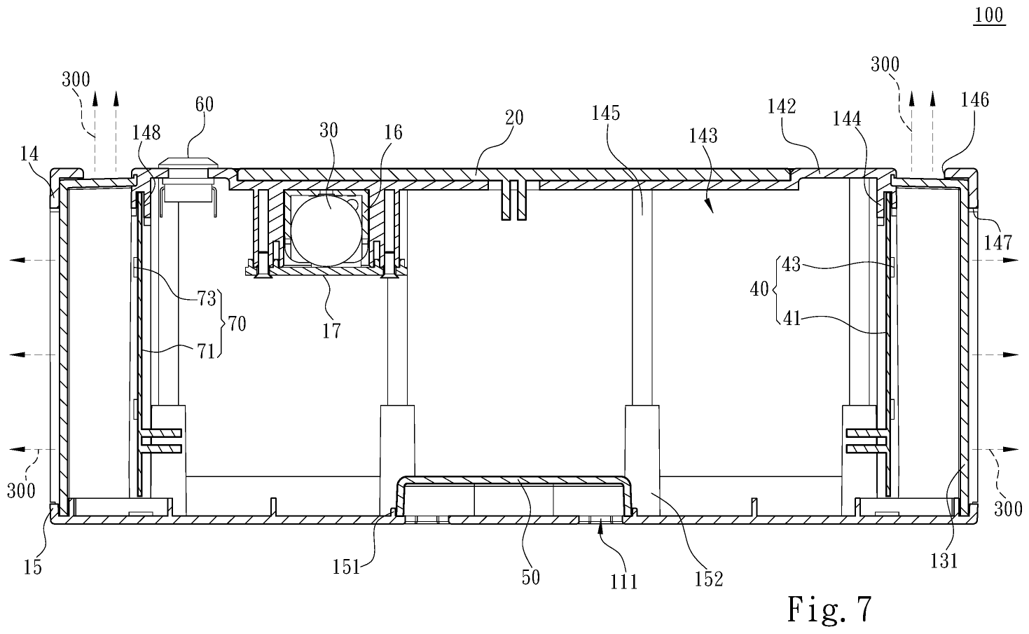

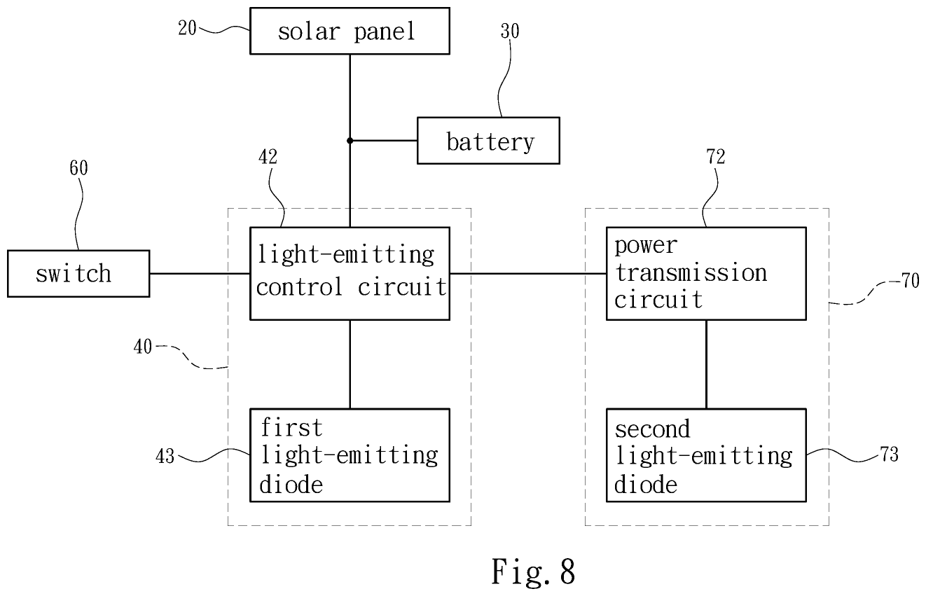

Referring to FIGS. 7 and 8, in one embodiment, the wall-mounted solar lamp 100 further defines the two light-transmissive ends 13 at two sides, one of the light-transmissive ends 13 is provided with the first light projecting unit 40, and the other one of the light-transmissive ends 13 is provided with a second light projecting unit 70 electrically connected to the first light projecting unit 40. In detail, the second light projecting unit 70 comprises a second circuit board 71, a power transmission circuit 72 disposed on the second circuit board 71 and connected to the light-emitting control circuit 42 to obtain electric power, and a plurality of second light-emitting diodes 73 disposed on the second circuit board 71 and connected to the power transmission circuit 72. Further, the second light projecting unit 70 is disposed on another mounting rail 148, and the light projecting mode of the second light projecting unit 70 is the same as the light projecting mode of the first light projecting unit 40. That is, the second light projecting unit 70 is not connected to the solar panel 20 or the switch 60, but is connected to the light-emitting control circuit 42 by the power transmission circuit 72, and enters the light projecting mode which is same as the light projecting mode of the first light projecting unit 40.

What is claimed is:

1. A wall-mounted solar lamp, capable of disposing on a building wall surface by a plurality of connectors, comprising:
a casing, defining a first surface contacting the building wall surface when assembled, a second surface paralleled to the first surface, and at least one light-transmissive end located at a side of the casing, the first surface of the casing being formed with a plurality of lateral mounting holes, and a plurality of longitudinal mounting holes perpendicular to the plurality of lateral mounting holes, the casing comprising a first installation state in which the plurality of lateral mounting holes being assembled with the plurality of connectors to enable the wall-mounted solar lamp to project light in parallel with a ground, and a second installation state in which the plurality of longitudinal mounting holes being assembled with the plurality of connectors to enable the wall-mounted solar lamp to project light perpendicular to the ground;
a solar panel flatly disposed on the second surface;
a battery disposed in the casing and connected to the solar panel; and
a first light projecting unit disposed at the at least one light-transmissive end, the first light projecting unit comprising a first circuit board installed in the casing and located at the at least one light-transmissive end, a light-emitting control circuit disposed on the first circuit board and obtained electric power from the solar panel or the battery, and a plurality of first light-emitting diodes disposed on the first circuit board and connected to the light-emitting control circuit.

2. The wall-mounted solar lamp as claimed in claim 1, wherein the wall-mounted solar lamp defines the two light-transmissive ends at two sides, one of the two light-transmissive ends is provided with the first light projecting unit, and the other one of the light-transmissive ends is provided with a second light projecting unit electrically connected to the first light projecting unit, the second light projecting unit comprises a second circuit board, a power transmission circuit disposed on the second circuit board and connected to the light-emitting control circuit to obtain electric power, and a plurality of second light-emitting diodes disposed on the second circuit board and connected to the power transmission circuit.

3. The wall-mounted solar lamp as claimed in claim 2, wherein the casing is composed of a U-shaped shell and a cover plate, the U-shaped shell comprises two side walls disposed in parallel with each other, a panel disposed between the two side walls and provided with the second surface, and an installation space defined and formed by the two side walls and the panel, the two side walls are formed with a plurality of mounting rails respectively provided for disposal of the first circuit board and the second circuit board, the cover plate is connected to the two side walls of the U-shaped shell, and the cover plate is provided with the plurality of longitudinal mounting holes and the plurality of lateral mounting holes.

4. The wall-mounted solar lamp as claimed in claim 3, wherein the casing comprises a mounting seat located in the installation space and mounted on the panel for disposal of the battery.

5. The wall-mounted solar lamp as claimed in claim 1, wherein the casing is composed of a U-shaped shell and a cover plate, the U-shaped shell comprises two side walls disposed in parallel with each other, a panel disposed between the two side walls and provided with the second surface, and an installation space defined and formed by the two side walls and the panel, the cover plate is connected to the two side walls of the U-shaped shell, and the cover plate is provided with the plurality of longitudinal mounting holes and the plurality of lateral mounting holes.

6. The wall-mounted solar lamp as claimed in claim 5, wherein the two side walls are respectively formed with a mounting rail for disposal of the first circuit board.

7. The wall-mounted solar lamp as claimed in claim 5, wherein the casing comprises a mounting seat located in the installation space and mounted on the panel for disposal of the battery.

8. The wall-mounted solar lamp as claimed in claim 1, wherein the wall-mounted solar lamp comprises a hood disposed in the casing and corresponding to the plurality of longitudinal mounting holes and the plurality of lateral mounting holes.

9. The wall-mounted solar lamp as claimed in claim 1, wherein each of the plurality of lateral mounting holes defines a first inlet section and at least one first limit section connecting the first inlet section to limit one of the plurality of connectors being detached from the plurality of lateral mounting holes, and each of the plurality of longitudinal mounting holes defines a second inlet section and at least one second limit section connecting the second inlet section to limit one of the plurality of connectors being detached from the plurality of longitudinal mounting holes.

10. The wall-mounted solar lamp as claimed in claim 1, wherein the wall-mounted solar lamp comprises a switch disposed on the casing and connected to the light-emitting control circuit.
